(19) United States
(12) Patent Application Publication
(10) Pub. No.: US 2006/0097470 A1
(43) Pub. Date: May 11, 2006

(54) Skateboard truck assembly

(76) Inventor: Erik Vaclav Chmelar, San Jose, CA (US)

Correspondence Address: ERIK CHMELAR, 3348 E. RYAN DR, MIDLAND, MI, 48642-7237, US

(21) Appl. No.: 10/983,276

(22) Filed: Nov. 8, 2004

(51) Int. Cl. B62M 1/00

(52) U.S. Cl. 280/87.042

(57) ABSTRACT

A truck assembly for a skateboard or the like that is configured to eliminate the undesired ride characteristic of wheel bite without sacrificing the turning responsiveness thereof and without deviating from the general shape and form of a typical skateboard truck. In the preferred embodiment of the invention each truck assembly includes an axle assembly with a ring-shaped member, disposed about a kingpin, that includes two threaded bores longitudinally oriented in the general plane of the ring-shaped member substantially parallel to the axis of the axle and on generally opposite sides of the kingpin, in each of which is positioned a bolt whose distance from the kingpin is determined by actuation of the bolt such that when the axle assembly pivots through an angle about the axis of the kingpin and causes one or more of the bolts to contact the kingpin, the contacting bolt or bolts resists any further pivoting of the axle assembly beyond that angle. In a further feature of the invention the kingpin is modified to define a flat edge along generally opposite sides thereof, each flat edge being adjacent to each bolt positioned within its respective threaded bore.

### BACKGROUND OF THE INVENTION

The present invention relates generally to vehicles that employ an axle or axle assembly that pivots relative to the vehicle to permit turning thereof and, more specifically, to a truck assembly that prevents the axle or axle assembly from pivoting beyond a specified angle relative to the vehicle. Such a truck assembly is of use for skateboards or other recreational vehicles to secure the wheels thereto.

A skateboard typically comprises an elongated platform with a pair of truck assemblies secured at opposite ends to the underside of the platform. Each truck assembly typically comprises a base that is non-moveably secured to the platform and a hanger assembly, which includes an axle, that is moveably secured to the base by means of a kingpin bolt such that the hanger assembly can pivot along the axis of the kingpin bolt relative to the base and the skateboard platform. The hanger and base of a typical skateboard truck assembly is formed of a durable and light-weight material such as cast aluminum and the axle and kingpin bolt are constructed of an extremely durable material such as hardened steel.

A pair of wheels can be secured at opposite ends of the axle. When a skateboarder shifts his weight to one side of the skateboard platform, the hanger assembly pivots relative to the platform and makes the distance between the wheels, whose plane of rotation remains unchanged relative to the axis of the axle, on that side of the platform shorter than the distance between the wheels on the other side of the platform, thereby causing the skateboard to turn.

The ability to adjust the steering responsiveness of a skateboard truck assembly is very important since different skateboarders may prefer a different steering responsiveness and even the same skateboarder may prefer a different steering responsiveness at different times. A desired steering responsiveness can be achieved by tightening or loosening a kingpin nut secured to the threaded end of the kingpin bolt of the truck assembly, which determines the ease at which the hanger assembly pivots along the axis of the kingpin bolt relative to the base and platform. Tightening the kingpin nut increases the resistance of the axle to pivot and makes the skateboard less willing to turn. Likewise, loosening the kingpin nut decreases the resistance of the axle to pivot and makes the skateboard more willing to turn.

There have been several truck assemblies previously proposed that can be used to secure wheels to a vehicle such as a skateboard and permit turning thereof.

U.S. Pat. No. 6,793,224 (Stratton) discloses a skateboard truck that pivots about two axes and provides a combination of adjustable lateral stability and enhanced turning abilities.

U.S. Pat. No. 6,547,262 (Yamada and Hiranuma) discloses a skateboard truck assembly in which the pivot arm of the truck hanger rotates freely in a bearing assembly supporting the pivot arm in the socket hub.

U.S. Pat. No. 6,523,837 (Kirkland) discloses an adjustable truck assembly for skateboards with a retainer that provides a large turning radius for the axle, a highly predictable turning performance, and tool-less adjustment of the turning performance.

U.S. Pat. No. 6,474,666 (Andersen and Andersen) discloses a shock-absorbing skate truck assembly that includes a resilient shock absorber at the kingpin located between the assembly base of the assembly and the axle support member for absorbing shocks encountered during use and another shock absorber that is located in a recess of the assembly base and is engaged by an axle support member arm.

U.S. Pat. No. 6,443,471 (Mullen) discloses a truck assembly configured to eliminate undesired ride characteristics such as hanger-jiggle and wheel bite without sacrificing the skateboard's steering responsiveness, which generally comprises an axle assembly with a ring-shaped hanger that is confined on a kingpin using a pair of bushings, at least one of which includes an annular flange that projects into an annular gap that is defined between the hanger and the kingpin.

U.S. Pat. No. 6,428,023 (Reyes and Horn) and U.S. Pat. No. 6,315,312 (Reyes and Horn) disclose a truck assembly including a housing adapted to be mounted to a skateboard or the like, which generally comprises an axle bracket that is mounted for rotation transverse to the longitudinal axis and that includes a projecting upper end portion and a bottom end portion adapted to receive a transversely extending axle and wheel assembly, a resilient member located at least partially in the housing that is adapted to resist transverse rotation of the axle bracket and provide a restoring force, and a wedge member that has an aperture configured for receiving the projecting upper end portion of the axle bracket to establish a direct coupling therebetween.

U.S. Pat. No. 6,367,819 (Andersen and Andersen) discloses a shock-absorbing skate truck assembly including a resilient shock absorber at the kingpin located between the assembly base of the assembly and the axle support member for absorbing shocks encountered during use.

U.S. Pat. No. 6,318,739 (Fehn, Jr.) discloses a suspension assembly for a skateboard which generally comprises a base plate with a truck plate pivotally attached at one end with a shock absorber located between the base plate and the truck plate and further with a projection on the base plate that protects the shock absorber and aids the rider in performing tricks.

U.S. Pat. No. 6,315,304 (Kirkland et. al.) discloses an adjustable truck assembly for a skateboard, which generally comprises an axle housing, a base, a kingpin connecting the axle housing and base, a turning mechanism between the axle housing and base around the kingpin consisting of opposed cam surfaces that are angled along the axis of the kingpin and an elastomeric bushing so that rotating the axle housing about the kingpin pushes the cam surfaces apart against the compression pressure of the elastomeric bushing, and an adjustment mechanism for adjusting the pressure against the bushing.

U.S. Pat. No. 6,224,076 (Kent) and U.S. Pat. No. D439,945 (Kent) disclose a pneumatic compression strut skateboard truck that utilizes a pneumatic compression strut suspension system, which is of the same type and kind used in automobiles and other mechanical devices employing shock absorbing technology.

U.S. Pat. No. 6,182,987 (Bryant) discloses a truck assembly with replaceable axles and ball joint pivots that incorporates precision steering and rocking components for consistency and accuracy during maneuvers, a method for removing or replacing worn or broken axles, and a precision ball pivot pin that acts as the associate pivotal and rocking mechanism for the truck assembly.

U.S. Pat. No. 5,971,411 (Jones and Jones) discloses a skateboard truck, which generally comprises an extruded skateboard truck base that has an angled aperture for a cushion on which a hanger rests and a pivot bolt that holds the hanger to the base and that allows weight placed on either side of the skateboard to put pressure on the cushion to facilitate a turn.

U.S. Pat. No. 5,263,725 (Gesmer and Haug) discloses a skateboard truck that incorporates exceptionally rapid and consistently accurate axle rebound to the straight-ahead position, consistent and predictable steering response, an improved balance between stability and maneuverability, fine steering control, and a wide range of steering radii, which generally comprises a yoke, a pivot pin, and coil springs.

U.S. Pat. No. 4,398,734 (Barnard) discloses a truck design for a skate-type device involving turning and tilting axes of rotation, which generally comprises a T-shaped rod, the top part being housed in a base plate and the leg passing through a slot in the base plate, a resilient pad, washers, an axle yoke, and an adjustable lock nut.

U.S. Pat. No. 4,251,087 (Hansen) discloses a truck apparatus for skate and skateboard devices, which generally comprises an elongated kingpin, a means for affixing the upper end of the kingpin to the bottom of a load carrying platform, a wheel axle carriage assembly pivotally affixed to the lower end of the kingpin and adapted to rotate about the axis of the kingpin, a resilient drag sleeve and turn restoring element compressively disposed between the first and second friction surfaces, and a lock nut for selectively urging the carriage assembly towards the mid-portioned member so as to compress the drag sleeve between the first and second friction surfaces such that the carriage assembly may be resistively and partially resiliently rotated about the axis of the kingpin.

U.S. Pat. No. 4,185,847 (Johnson) and U.S. Pat. No. 4,176,850 (Johnson) disclose skateboard trucks that carry a plurality of wheels mounted in independent suspension, which generally comprise longitudinally extending arms that carry the wheel axles forwardly or rearwardly relative to a mounting that secures the arms in rotatable fashion to the trucks and that are resiliently biased by means of separate springs or torsion bars.

U.S. Pat. No. 4,184,693 (Whitmarsh) discloses a skateboard truck, which generally comprises a base plate for securing to the underside of a skateboard platform and a spring member, such as a plate spring, that is joined to the base plate by one end and carries a wheel axle near an opposite end.

U.S. Pat. No. 4,166,629 (List) discloses a skateboard truck, which generally comprises a base that has a first portion with a first hole therein and a second portion with a second hole therethrough, a hanger that has an axle for mounting wheels thereon, a ring and a pin, the pin being received in the first hole, and a coupling assembly for coupling the hanger to the base.

U.S. Pat. No. 4,152,001 (Christianson) discloses a truck for a skateboard or the like, which generally comprises an S-shaped leaf spring that attaches to the skateboard and, through a pivot pin, carries a transverse axle-supporting member at the opposite end and further generally comprises a pair of upwardly and inwardly inclined compression springs that are engaged by a pin carried by the leaf spring to resist pivotal movement of the leaf spring relative to the axle-supporting member.

U.S. Pat. No. 4,103,917 (Widolf) discloses a skateboard truck, which generally includes a wheel housing resiliently mounted on a skateboard truck base by means of a fastener which extends through the housing and is threaded onto a stud fixed to the base to compress a tubular cushion between the housing and the base, in which the fastener has a square cross-section that mates with a square bore in the cushion so that rotation of the fastener with respect to the cushion is prevented except when the retainer is manually and forceably rotated to adjust the compression on the cushion.

Although these prior art truck assemblies are capable of securing wheels to a vehicle such as a skateboard and permit turning thereof, they suffer from one or more disadvantageous properties. Skateboarders have become accustomed to the general shape and form of a typical skateboard truck assembly, so much that many of the maneuvers a skateboarder performs relies on this general property. Therefore, the above previously proposed truck assemblies that deviate significantly from the general shape and form of a typical skateboard truck assembly are highly undesired.

The remaining above previously proposed truck assemblies that do not deviate significantly from the general shape and form of a typical skateboard truck assembly have a design flaw that can result in an undesired ride characteristic called wheel bite. When a skateboarder uses his skateboard to perform maneuvers, such as riding off an obstacle, his balance may not be completely centered upon the skateboard platform. Such an uneven distribution of weight can cause the hanger assembly to pivot through a great angle relative to the platform and cause the wheels to contact the platform, called wheel bite. Wheel bite can cause the wheels to stop rotating and the skateboard to stop moving, and often causes the skateboarder to fall. The only way to prevent wheel bite is to tighten the kingpin nut to sufficiently retard the pivoting action of the hanger assembly, but this inhibits the steering responsiveness of the skateboard and is therefore highly undesired. Although U.S. Pat. No. 6,443,471 (Mullen) claims to solve wheel bite by providing a bushing with an annular flange, it still relies on the tightness or looseness of a kingpin nut to function and therefore affects the steering responsiveness of the skateboard. Furthermore, because the device of U.S. Pat. No. 6,443,471 (Mullen) is comprised of a soft material, it cannot completely prevent wheel bite.

Accordingly, what is desired, and has not heretofore been developed, is a truck assembly that has the same general shape and form of a typical skateboard truck assembly but can prevent wheel bite without affecting the steering responsiveness of the skateboard. Furthermore, because a skateboard can be configured with differently sized wheels and because skateboard platforms can have different degrees of concavity such that the angle through which the hanger assembly must pivot to cause wheel bite can be different for different skateboards, what is desired, and has not heretofore been developed, is a skateboard truck assembly in which the maximum angle through which the hanger assembly can pivot is easily adjusted by the user.

### BRIEF SUMMARY OF THE INVENTION

It is an object of the present invention to provide a skateboard truck assembly that prevents wheel bite.

It is an object of the present invention to provide a skateboard truck assembly wherein the maximum angle through which the hanger assembly can pivot relative to the skateboard platform is easily adjusted by the user.

It is an object of the present invention to provide a skateboard truck assembly wherein the maximum angle through which the hanger assembly can pivot relative to the skateboard platform is independent to its pivot sensitivity and therefore independent to the steering responsiveness of the skateboard.

It is an object of the present invention to provide a skateboard truck assembly that is inexpensive to manufacture.

It is an object of the present invention to provide a skateboard truck assembly that is easy to use.

It is an object of the present invention to provide a skateboard truck assembly that does not deviate significantly from the general shape and form of typical skateboard truck assembly.

It is an object of the present invention to provide a skateboard truck assembly whose turning responsiveness does not deviate significantly from that of a typical skateboard truck assembly.

The above comments apply equally to any vehicle that employs a hanger assembly that pivots relative to the vehicle to permit turning thereof. Furthermore, the above comments apply equally to any wheel-securing, blade-securing, or other device-securing assembly that employs a pivoting axle or axle assembly for which it is desired to specify a maximum angle through which the axle or axle assembly can pivot relative to the vehicle while not affecting the pivot sensitivity of the axle or axle assembly.

The above objects, features, and advantages of the present invention will become apparent from the following detailed description when read in conjunction with the accompanying drawings, which illustrate by way of example, the principles of the invention. The same reference numerals are used to identify the same or similar parts in each of the accompanying drawings.

### BRIEF DESCRIPTION OF THE DRAWINGS

FIG. 1 is a perspective view of a typical prior art skateboard truck assembly.

FIG. 2 is a bottom view of the prior art skateboard truck assembly shown in FIG. 1.

FIG. 3 is a side view of the prior art skateboard truck assembly shown in FIG. 1.

FIG. 4 is a cross-sectional view of the prior art skateboard truck assembly shown in FIG. 2 taken along line A-A.

FIG. 5a is a perspective view of the two set screws used in the first embodiment of the present invention, FIG. 5b is a perspective view of the modified kingpin that may be used in the first embodiment of the present invention, and FIG. 5c is a perspective view of the bushings that may be used in the first embodiment of the present invention.

FIG. 6a and FIG. 6b are cross-sectional views of the hanger of a skateboard truck assembly, like that shown in FIG. 3 taken along line B-B, that is modified to accept and accepting the device of FIG. 5a and FIG. 5b.

FIG. 7a through FIG. 7d are cross-sectional views of the device shown in FIG. 5a when engaged to a hanger and with a kingpin bolt therebetween, in which the maximum angle through which the device can pivot along the axis of the kingpin bolt is shown.

FIG. 8 is a view of the different parts of a skateboard truck assembly, like that shown in FIG. 1, that is modified to accept the devices shown in FIG. 5a, FIG. 5b, and FIG. 5c.

FIG. 9 is a perspective view of the assembled skateboard truck assembly shown in FIG. 8.

FIG. 10 is a perspective view of a second embodiment of the present invention.

FIG. 11a and FIG. 11b are cross-sectional views of the hanger of a skateboard truck assembly, like that shown FIG. 3 taken along line C-C, that is modified to accept and accepting the device of FIG. 10.

FIG. 12 is a view of the different parts of a skateboard truck assembly, like that shown in FIG. 1, that is modified to accept the device shown in FIG. 10.

FIG. 13 is a perspective view of the assembled skateboard truck assembly shown in FIG. 12 or FIG. 18.

FIG. 14 is a perspective view of a third embodiment of the present invention.

FIG. 15 is a cross-sectional view of a skateboard truck assembly, like that shown in FIG. 2 taken along line A-A, that is modified to accept and accepting the device of FIG. 14.

FIG. 16a and FIG. 16b are cross-sectional views of the hanger of a skateboard truck assembly, like that shown in FIG. 3 taken along line B-B, that is modified to accept and accepting the device of FIG. 14.

FIG. 17a through FIG. 17d are cross-sectional views of the device shown in FIG. 14 when engaged to a hanger and with a kingpin bolt therethrough, in which the maximum angle through which the device can pivot along the axis of the kingpin is shown.

FIG. 18 is a view of the different parts of a skateboard truck assembly, like that shown in FIG. 1, that is modified to accept the device shown in FIG. 14.

### DETAILED DESCRIPTION OF THE INVENTION

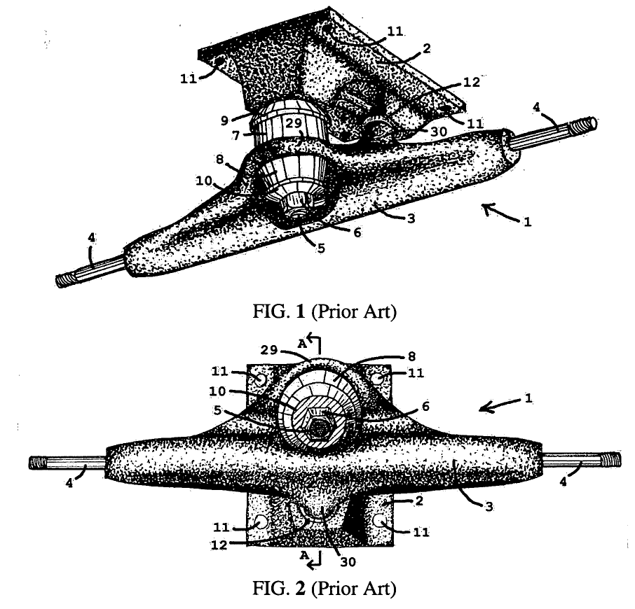

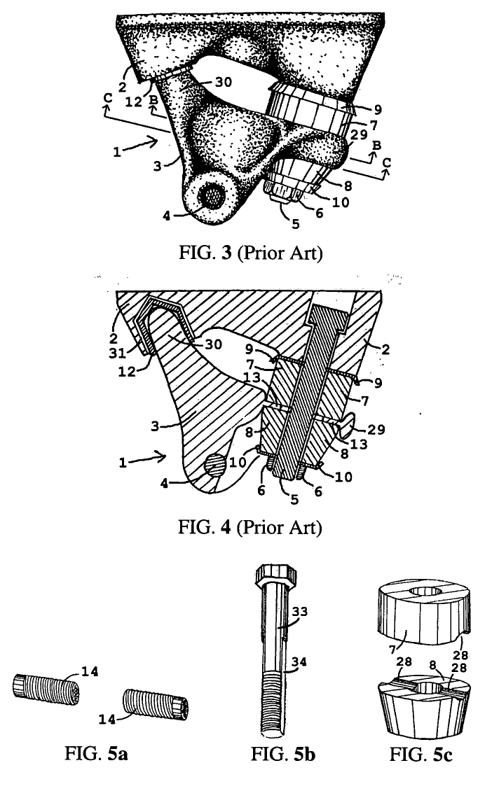

FIG. 1 shows a perspective view of a typical prior art skateboard truck assembly 1, which generally comprises a base 2 and a hanger 3. The hanger 3 includes an axle 4, on which wheels can be secured, a ring-shaped member 29 through which a kingpin bolt 5 is positioned, and a pivot stem 30 that extends into a pivot cup 12 that rests in a recess defined in the base 2 on which the hanger 3 can pivot. The base 2 is non-moveably secured to a skateboard platform by means of a plurality of mounting holes 11 through which bolts can be inserted. The hanger 3 is moveably secured to the base 2 by sandwiching part of the ring-shaped member 29 between an upper bushing 7, above which resides an upper bushing upper washer 9, and a lower bushing 8, below which resides a lower bushing lower washer 10, through which is routed the kingpin bolt 5 whose non-threaded end is secured to the base 2 and on whose threaded end a kingpin nut 6 is secured. FIG. 2 and FIG. 3 show a bottom elevation view and a side elevation view, respectively, of the typical prior art skateboard truck assembly 1 shown in FIG. 1.

FIG. 4 shows a cross-sectional view of the prior art skateboard truck assembly 1 shown in FIG. 2 taken along the line A-A. The upper bushing 7, lower bushing 8, upper bushing upper washer 9, lower bushing lower washer 10, and ring-shaped member 29 each has a bore defined therethrough through which the kingpin bolt 5 is routed. The flange 13 is the part of the ring-shaped member 29 that is sandwiched between the upper bushing 7 and lower bushing 8 by means of the kingpin nut 6 secured to the threaded end of the kingpin bolt 5, securing the hanger 3 and axle 4 to the base 2. Because there is an annular space between the kingpin bolt 5 and the flange 13 and because the upper bushing 7 and lower bushing 8 are formed of a pliable material such as polyurethane, the described configuration permits the hanger 3 and axle 4 to pivot along the axis of the kingpin bolt 5 relative to the base 2 on the pivot stem 30 that extends into a pivot cup 12 that rests in the recess 31 defined in the base 2.

In the above-described prior art skateboard truck assembly 1 the ease at which the hanger 3 can pivot along the axis of the kingpin bolt 5 relative to the base 2 is determined by how tightly the flange 13 is sandwiched between the upper bushing 7 and lower bushing 8. To increase the resistance of the hanger 3 to pivot along the axis of the kingpin bolt 5 relative to the base 2, which decreases the steering responsiveness of the skateboard, the kingpin nut 6 is tightened such that increased pressure is applied to the flange 13 by the upper bushing 7 and lower bushing 8. Likewise, to decrease the resistance of the hanger 3 to pivot along the axis of the kingpin bolt 5 relative to the base 2, which increases the steering responsiveness of the skateboard, the kingpin nut 6 is loosened such that decreased pressure is applied to the flange 13 by the upper bushing 7 and lower bushing 8. Although it is highly desired for a skateboard to have a sensitive steering responsiveness, the required decreased resistance of the hanger 3 to pivot can result in the hanger 3 pivoting through a great angle along the axis of the kingpin bolt 5 relative to the base 2 such that the wheels, which are secured to the ends of the axle 4, contact the underside of the skateboard platform, called wheel bite.

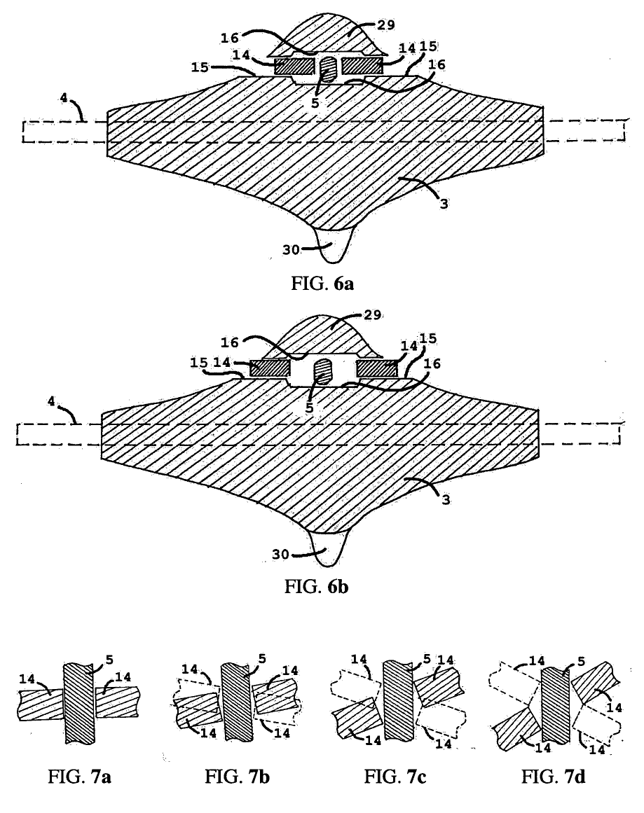

FIG. 5a shows an elevation view of a pair of set screws 14 that are part of the first embodiment of the present invention, whose purpose is to stop the hanger 3 and axle 4, like those shown in FIG. 1, from pivoting beyond a specified angle along the axis of the kingpin bolt 5 relative to the base 2 by contacting the kingpin bolt 5. FIG. 5b shows an elevation view of a modified kingpin bolt 33 that can also be part of the first embodiment of the present invention, which has a flattened edge 34 defined along boths sides thereon, permitting the set screws 14 to make secure contact thereto. FIG. 6a and FIG. 6b, which are cross-sectional views of the hanger 3 of a skateboard truck assembly 1 like that shown in FIG. 3 taken along the line B-B when the hanger 3 and axle 4 are in the non-pivoting position relative to the base 2, show the set screws 14 engaged to the hanger 3 through a pair of threaded bores 15 defined in the ring-shaped member 29, which are longitudinally oriented in the general plane of the ring-shaped member 29 substantially parallel to the axis of the axle 4 on generally opposite sides of the modified kingpin bolt 33, such that the distance between the end of each set screw 14 and the modified kingpin bolt 33 is determined by the amount each set screw 14 is actuated into or out of its respective threaded bore 15.

FIG. 6a shows the position of each set screw 14 when it is fully actuated into its respective threaded bore 15, in which the end of each set screw 14 is nearly contacting or contacting the modified kingpin bolt 33. Likewise, FIG. 6b shows the position of each set screw 14 when it is fully actuated out from its respective threaded bore 15 but not yet removed from the hanger 3, in which there is ample space between each set screw 14 and the modified kingpin bolt 33.

An extended flange 16 is defined in the ring-shaped member 29 of the hanger 3 that reduces the gap between the ring-shaped member 29 and the modified kingpin bolt 33 on either side of the modified kingpin bolt 33 in the direction perpendicular to the axis of the axle 4. When the hanger 3 pivots through a specified angle along the axis of the modified kingpin bolt 33 relative to the base 2 and causes one or both set screws 14 to contact the modified kingpin bolt 33, which resists any further pivoting of the hanger 3 beyond that angle, the extended flange 16 prevents the hanger 3 from moving relative to the modified kingpin bolt 33 in the plane of the ring-shaped member 29 in the direction generally perpendicular to the axis of the axle 4.

FIG. 7a through FIG. 7d show, by means of cross-sectional views of each set screw 14 and the modified kingpin bolt 33 positioned therebetween, the pivot action of the set screws 14, which are in secured to the hanger 3 as shown in FIG. 6a and FIG. 6b, along the axis of the modified kingpin bolt 33, which is secured to the base 2 as shown in FIG. 4. The gap between the end of each set screw 14 and the modified kingpin bolt 33 determines the maximum angle through which the hanger 3 and axle 4 can pivot along the axis of the modified kingpin bolt 33 relative to the base 2. In FIG. 7a the end of each set screw 14 is actuated to be nearly in contact or in contact with the modified kingpin bolt 33, completely preventing the hanger 3 and axle 4 from pivoting along the axis of the modified kingpin bolt 33 relative to the base 2. In FIG. 7d the end of each set screw 14 is actuated a distance far from the modified kingpin bolt 33 such that the hanger 3 and axle 4 can pivot through a great angle along the axis of the modified kingpin bolt 33 relative to the base 2 before causing one or both set screws 14 to contact the modified kingpin bolt 33. FIG. 7b and FIG. 7c show intermediate distances of the end of each set screw 14 from the modified kingpin bolt 33, which permit intermediate maximum angles through which the hanger 3 and axle 4 can pivot along the axis of the modified kingpin bolt 33 relative to the base 2.

Because the actuation of each set screw 14 into its threaded bore 15 or the actuation of each set screw 14 out from its threaded bore 15 is in a direction generally perpendicular to the axis of the modified kingpin bolt 33 (or kingpin bolt 5 if a modified kingpin bolt 33 is not used), the maximum angle through which the hanger 3 and axle 4 can pivot along the modified kingpin bolt 33 relative to the base 2 is independent to the tightness or looseness of the kingpin nut 6 secured to the threaded end of the modified kingpin bolt 33, and is therefore independent to the steering responsiveness of the skateboard.

If the thickness of the flange 13 or extended flange 16 is not increased to be be larger than the diameter of the set screws 14, a channel 28, which is shown in FIG. 5c, can be defined on the lower side of the upper bushing 7 and the upper side of the lower bushing 8 adjacent to each set screw 14 to provide substantially unimpeded actuation of each set screw 14 towards or away from the modified kingpin bolt 33.

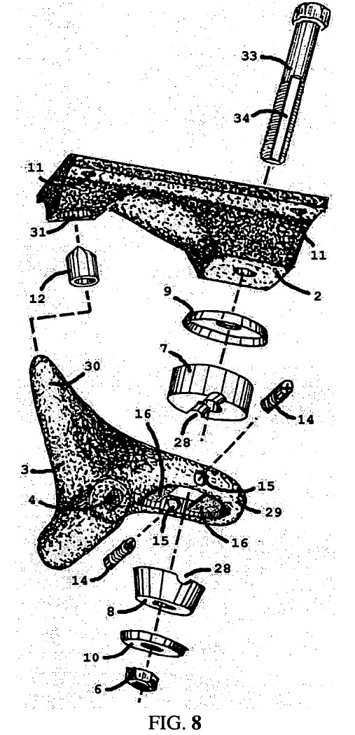

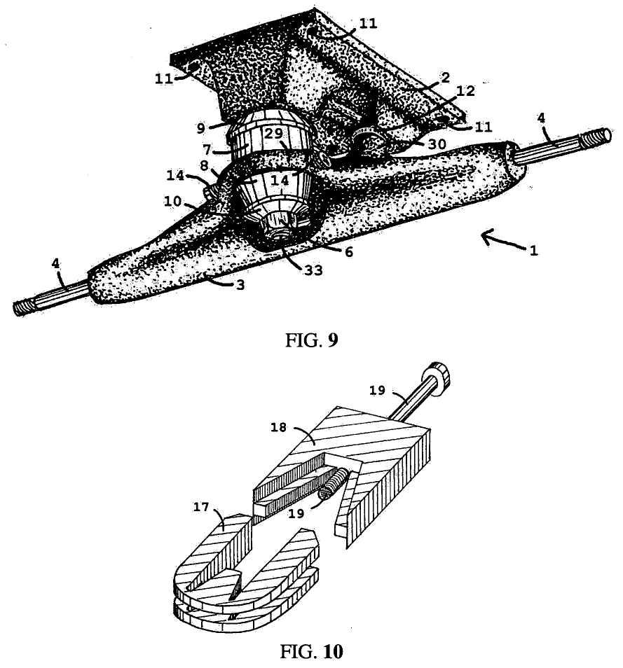

FIG. 8 shows how each set screw 14 is engaged to a skateboard truck assembly 1, which consists of a hanger 3 that includes an axle 4 and a base 2 that has several mounting holes 11 for securement to a skateboard platform. The modified kingpin bolt 33 is inserted through the top of the base 2, through the upper bushing upper washer 9, upper bushing 7 which rests on the extended flange 16 and on the bottom of which is defined a channel 28, lower bushing 8 on which rests the extended flange 16 and on the top of which is defined a channel 28, and lower bushing lower washer 10. The kingpin nut 6 is secured to the threaded end of the modified kingpin bolt 33 to secure the hanger 3 to the base 2. The pivot stem 30 extends into the pivot cup 12 that rests in a recess 31 defined in the base 2. Each set screw 14 is inserted into its respective threaded bore 15, which is defined in or near the ring-shaped member 29, and actuated such that the end of each set screw 14 is positioned at a desired distance from the flattened edge 34 of the modified kingpin bolt 33. FIG. 9 shows the assembled skateboard truck assembly 1 shown in FIG. 8, which has the same general shape, form, and steering characteristics of a typical skateboard truck assembly but can prevent wheel bite.

It is apparent that various modifications can be made to the first embodiment of the present invention described above without departing from the spirit and scope of the invention. For example, although each set screw 14 shown in FIG. 5a is drawn as a headless bolt to reduce any protrusion of the set screw 14 from the exterior of the hanger 3 that may result, any type of bolt or actuation element can be used. Furthermore, employing a modified kingpin bolt 33 with a flattened edge 34 defined along either side can be beneficial to ensure secure contact of each set screw 14 thereto, but it is not required. Also, although the longitudinal orientation of each threaded bore 15 is shown parallel to each other in FIG. 6a and FIG. 6b, it may be advantageous to define an angle therebetween. Even elements other than a pair of bolts can be used to contact the kingpin bolt 5 or modified kingpin bolt 33 when the hanger 3 and axle 4 pivot through a specified angle along the axis of the kingpin bolt 5 or modified kingpin bolt 33 relative to the base 2 and, furthermore, the means of actuating the element or elements can be either directly or indirectly accomplished via actuation of another element or elements. Accordingly, drawings for second and third embodiments of the present invention are included, which are briefly described below.

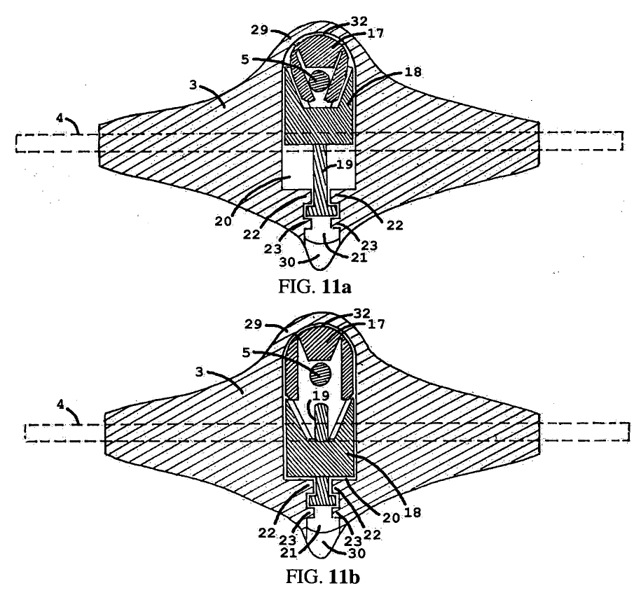

FIG. 10 shows a second embodiment of the present invention, which generally comprises a c-shaped element 17, a wedge element 18, and a screw 19 that is engaged to the wedge element 18. FIG. 11a and FIG. 11b, which are cross-sectional views of the hanger 3 of a skateboard truck assembly 1 like that shown in FIG. 3 taken along the line C-C, show the device of FIG. 10 engaged to the hanger 3 in a first bore 20 that is defined partially in the part of the ring-shaped member 29 nearest the axle 4 for accepting the c-shaped element 17 and partially in the hanger 3 for accepting the wedge element 18, and a second bore 21 that is defined in the hanger 3 for accepting the screw 19. The c-shaped element 17 rests on a partial flange 32 that is defined in the ring-shaped member 29 and the wedge element 18 is engaged by the screw 19.

FIG. 11a shows the generally perpendicular position of the c-shaped element 17, the wedge element 18, and the screw 19 relative to the axis of the kingpin bolt 5 when the screw 19, whose head rests between a first flange 22 and a second flange 23 that are both defined in the second bore 21 of the hanger 3, is actuated such that the wedge element 18, to which it is engaged, is pushed towards the kingpin bolt 5, causing the c-shaped element 17 to close in towards the kingpin bolt 5. Likewise, FIG. 11b shows the position of the c-shaped element 17, the wedge element 18, and the screw 19 when the screw 19 is actuated such that the wedge element 18 is pulled away from the kingpin bolt 5, causing the c-shaped element 17 to open up away from the kingpin bolt 5. Similar to the first embodiment of the present invention, the gap between the c-shaped element 17 and the kingpin bolt 5, determined by the position of the wedge element 18 relative to the c-shaped element 17, determines the maximum angle through which the hanger 3 and axle 4 can pivot along the axis of the kingpin bolt 5 relative to the base 2 on the pivot stem 30.

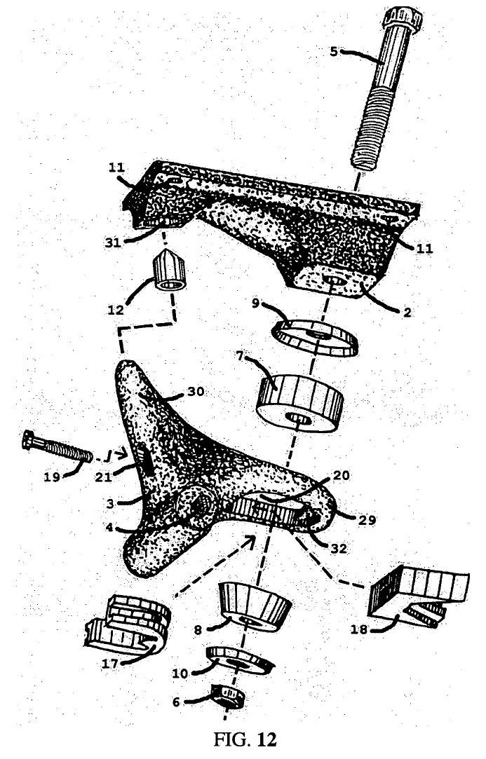

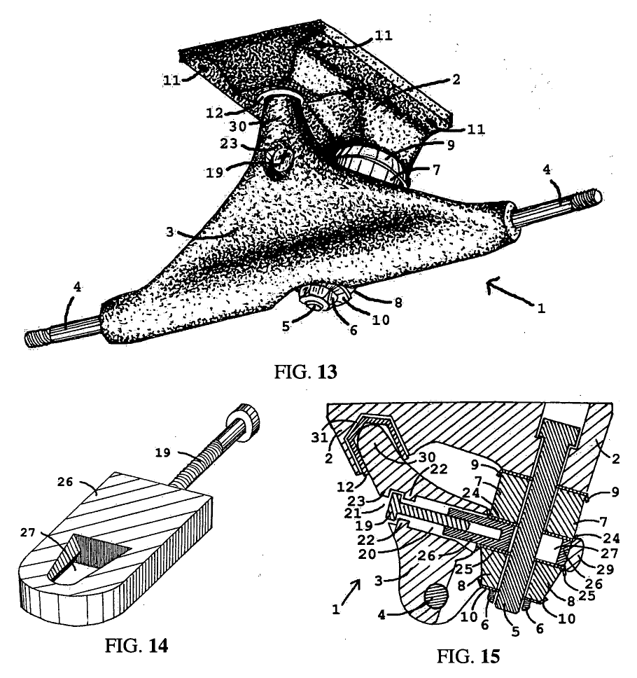

FIG. 12 shows how the c-shaped element 17, wedge element 18, and screw 19 are engaged to a skateboard truck assembly 1 that consists of a hanger 3 that includes an axle 4 and a base 2 that has several mounting holes 11 for securement to a skateboard platform. The c-shaped element 17 is inserted into the part of the first bore 20 defined in the ring-shaped member 29 and rests on the partial flange 32, the wedge element 18 is inserted into the part of the first bore 20 defined in the hanger 3, and the screw 19 is inserted into the second bore 21 defined in the hanger 3 and engaged to the wedge element 18. The kingpin bolt 5 is inserted through the top of the base 2, through the upper bushing upper washer 9, upper bushing 7 which rests on the c-shaped element 17, lower bushing 8 on which rests the c-shaped element 17, and lower bushing lower washer 10. The kingpin nut 6 is secured to the threaded end of the kingpin bolt 5 to secure the hanger 3 to the base 2. The pivot stem 30 extends into the pivot cup 12 that rests in a recess 31 defined in the base 2. FIG. 13 shows the assembled skateboard truck assembly 1 shown in FIG. 12 which has the same general shape, form, and steering characteristics of a typical skateboard truck assembly but can prevent wheel bite. The head of the screw 19 is positioned against the second flange 23.

FIG. 14 shows a third embodiment of the present invention, which generally comprises an elongated element 26, which has a trapezoidal-shaped bore 27 defined therein, and a screw 19 engaged thereto. FIG. 15, which is a cross-sectional view of a skateboard truck assembly 1 like that shown in FIG. 2 taken along the line A-A, shows the device of FIG. 14 engaged to the hanger 3, which includes the axle 4, in a first bore 20 that is defined partially in the ring-shaped member 29 and partially in the hanger 3 for accepting the elongated element 26 and a second bore 21 that is defined in the hanger 3 for accepting the screw 19, both of which are generally perpendicular to the axis of the kingpin bolt 5.

Actuating the screw 19, whose head rests between a first flange 22 and a second flange 23, causes the elongated element 26 to move relative to the kingpin bolt 5, which is routed through the trapezoidal-shaped bore 27 defined in the elongated element 26, such that the kingpin bolt 5 can be positioned at different locations within the trapezoidal-shaped bore 27. Because a void will exist between the upper bushing 7 and lower bushing 8 on the exterior of the elongated element 26 when the elongated element 26 is moved nearer to the head of the screw 19, an upper bushing lower washer 24 is placed below the upper bushing 7 and a lower bushing upper washer 25 is placed above the lower bushing 8 in addition to the upper bushing upper washer 9 that resides above the upper bushing 7 and the lower bushing lower washer 10 that resides below the lower bushing 8. The kingpin nut 6 is secured to the threaded end of the kingpin bolt 5 to secure the hanger 3 to the base 2. The pivot stem 30 extends into the pivot cup 12 that rests in a recess 31 defined in the base 2.

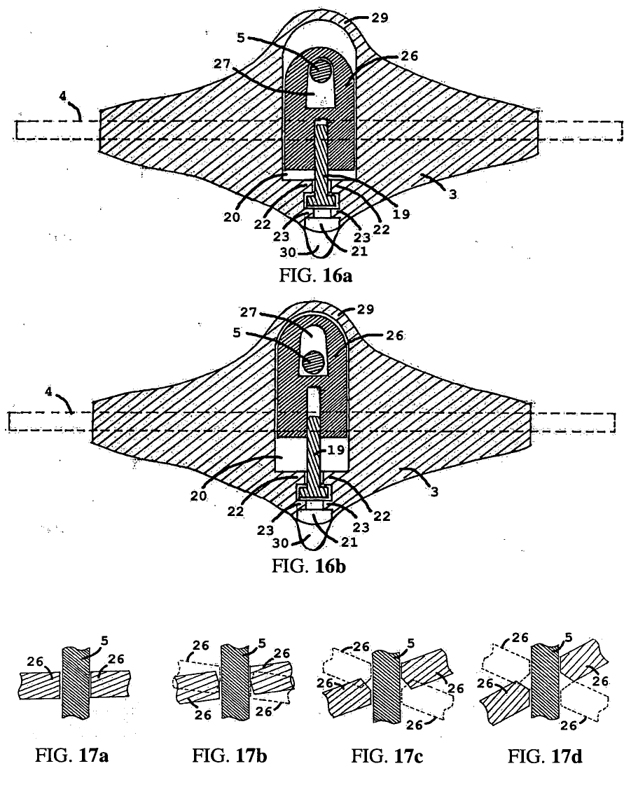

FIG. 16a and FIG. 16b, which are cross-sectional views of the hanger 3 of a skateboard truck assembly 1 like that shown in FIG. 3 taken along the line B-B, show the device of FIG. 14 engaged to the hanger 3 through a first bore 20 defined therein for accepting the elongated element 26 and a second bore 21 for accepting the screw 19. FIG. 16a shows the position of the elongated element 26 within both the ring-shaped member 29 and hanger 3 and the position of the screw 19, whose head rests between a first flange 22 and a second flange 23, when the screw 19 is actuated such that the narrow end of the trapezoidal-shaped bore 27 that is defined in the elongated element 26 is pulled towards the kingpin bolt 5. Likewise, FIG. 16b shows the position of the elongated element 26 and the screw 19 when the screw 19 is actuated such that the narrow end of the trapezoidal-shaped bore 27 is pushed away from the kingpin bolt 5. Similar to the first embodiment of the present invention, the gap between the elongated element 26 and the kingpin bolt 5, defined by the position of the kingpin bolt 5 within the trapezoidal-shaped bore 27, determines the maximum angle through which the hanger 3 and axle 4 can pivot along the axis of the kingpin bolt 5 relative to the base 2 on the pivot stem 30. FIG. 17a through FIG. 17d show, by means of cross-sectional views of the elongated element 26 and kingpin bolt 5 positioned therethrough, the pivot action of the elongated element 26, which is secured to the hanger 3 as shown in FIG. 16a and FIG. 16b, along the axis of the kingpin bolt 5, which is secured to the base 2 as shown in FIG. 15.

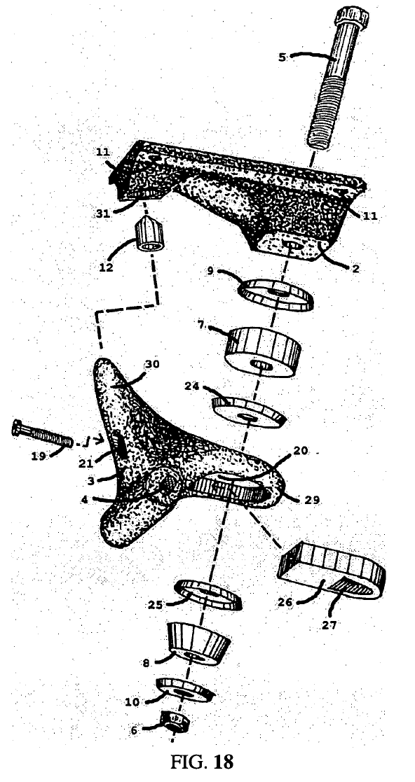

FIG. 18 shows how the elongated element 26, in which the trapezoidal-shaped bore 27 is defined, and the screw 19 are engaged to a skateboard truck assembly 1 that consists of a hanger 3 that includes an axle 4 and a base 2 that has several mounting holes 11 for securement to a skateboard platform. The elongated element 26 is inserted into the first bore 20 defined in both the ring-shaped member 29 and hanger 3 and the screw 19 is inserted into the second bore 21 defined in the hanger 3 and engaged to the elongated element 26. The kingpin bolt 5 is inserted through the top of the base 2, through the upper bushing upper washer 9, upper bushing 7, upper bushing lower washer 24 which rests on the elongated element 26, lower bushing upper washer 25 on which rests the elongated element 26, lower bushing 8, and lower bushing lower washer 10. The kingpin nut 6 is secured to the threaded end of the kingpin bolt 5 to secure the hanger 3 to the base 2. The pivot stem 30 extends into the pivot cup 12 that rests in a recess 31 defined in the base 2. FIG. 13 shows the assembled skateboard truck assembly 1 shown in FIG. 18 which has the same general shape, form, and steering characteristics of a typical skateboard truck assembly but can prevent wheel bite. The head of the screw 19 is positioned against the second flange 23.

Although several specific embodiments of the present invention have been illustrated and described, many variations or modifications would be apparent that do not depart from the spirit and scope of the invention, which are defined by the appended claims.

1. A truck assembly for a vehicle comprising:
a base configured to be secured to the underside of said vehicle, said base configured to have an underside that defines a pivot recess;
a kingpin projecting downwardly from the underside of said base, from a location spaced from said pivot recess, wherein said kingpin is oriented at a specified angle towards said pivot recess, and wherein said kingpin and said pivot recess are configured to be aligned parallel to the primary direction of travel of said vehicle;
an axle assembly including
an axle,
one or more devices secured to the opposite ends of said axle to aid in locomotion of said vehicle,
a ring-shaped member projecting from a mid portion of said axle, said ring-shaped member defining an opening sized to be larger than the cross section of said kingpin, and said ring-shaped member including a plurality of bores that are longitudinally oriented in the general plane of said ring-shaped member,
a pivot stem projecting from a mid portion of said axle, said pivot stem configured to be seated in said pivot recess,
wherein said axle assembly is secured to the underside of said base with said axle configured to be oriented substantially perpendicular to the primary direction of travel of said vehicle, with said pivot stem seated in said pivot recess, and with said ring-shaped member disposed around said kingpin, wherein a gap is defined between said ring-shaped member and said kingpin;
a bushing assembly disposed on said kingpin, said bushing assembly adjacent to said ring-shaped member, said bushing assembly permitting limited pivoting of said axle assembly about the axis of said kingpin; and
at least one actuation element positioned in at least one of said bores defined in said ring-shaped member wherein the distance between said actuation element from and said kingpin is determined by actuation of said actuation element and wherein said actuation element is formed of a sufficiently strong material and is sufficiently secure at its actuated location in said bore such that when said axle assembly pivots through an angle about axis of said kingpin and causes at least one said actuation element to contact said kingpin, said contacting actuation element resists any further pivoting of said axle assembly beyond that angle.

2. The truck assembly of claim 1 wherein said vehicle is a skateboard.

3. The truck assembly of claim 1 wherein said device or devices secured to the opposite ends of said axle to aid in locomotion of said vehicle are wheels.

4. The truck assembly of claim 1 wherein said ring-shaped member includes two bores that are longitudinally oriented in the general plane of said ring-shaped member substantially parallel to the axis of said axle and on generally opposite sides of said kingpin, said ring-shaped member further including at least one actuation element in each of said two bores.

5. The truck assembly of claim 1 wherein
said vehicle is a skateboard,
said device or devices secured to the opposite ends of said axle are wheels,
said ring-shaped member includes two bores that are longitudinally oriented in the general plane of said ring-shaped member substantially parallel to the axis of said axle and on generally opposite sides of said kingpin,
and said ring-shaped member includes at least one set screw in each of said two bores.

6. The truck assembly of claim 1 wherein said bushing assembly includes a first bushing that is positioned below said ring-shaped member and a second bushing that is positioned above said ring-shaped member, wherein a channel is defined on at least one of said bushings, said channel adjacent to at least one said actuation element.

7. The truck assembly of claim 1 wherein the opening defined by said ring-shaped member in the direction generally perpendicular to the axis of said axle is only slightly larger than the cross-sectional diameter of said kingpin such that movement of said axle assembly in the plane of said ring-shaped member in the direction generally perpendicular to the axis of said axle is prevented.

8.

9. The truck assembly of claim 1 wherein said kingpin includes at least one flat area along the shaft of said kingpin at or near the location where at least one actuation element may contact said kingpin.

10. The truck assembly of claim 1 wherein the thickness of a flange defined within said ring-shaped member is larger than the diameter of said actuation element.

11. A truck assembly for a vehicle comprising:
a base configured to be secured to the underside of said vehicle, said base configured to have an underside that defines a pivot recess;
a kingpin projecting downwardly from the underside of said base, from a location spaced from said pivot recess, wherein said kingpin is oriented at a specified angle towards said pivot recess, and wherein said kingpin and said pivot recess are configured to be aligned parallel to the primary direction of travel of said vehicle;
an axle assembly including
an axle,
one or more devices secured to the opposite ends of said axle to aid in locomotion of said vehicle,
a ring-shaped member projecting from a mid portion of said axle, said ring-shaped member including at least one rigid element disposed therein, said rigid element defining an opening sized to be larger than the cross section of said kingpin,
a pivot stem projecting from a mid portion of said axle, said pivot stem configured to be seated in said pivot recess,
wherein said axle assembly is secured to the underside of said base with said axle configured to be oriented substantially perpendicular to the primary direction of travel of said vehicle, with said pivot stem seated in said pivot recess, and with said ring-shaped member and said rigid element disposed around said kingpin wherein a gap is defined between said rigid element and said kingpin and wherein said rigid element is formed of a sufficiently strong material and is sufficiently secure at its location in said ring-shaped member such that when said axle assembly pivots through an angle about the axis of said kingpin and causes said rigid element to contact said kingpin, said rigid element resists any further pivoting of said axle assembly beyond that angle; and
a bushing assembly disposed on said kingpin, said bushing assembly adjacent to said ring-shaped member and said rigid element, said bushing assembly permitting limited pivoting of said axle assembly about the axis of said kingpin.

12. The truck assembly of claim 11 wherein said vehicle is a skateboard.

13. The truck assembly of claim 11 wherein said device or devices secured to the opposite ends of said axle to aid in locomotion of said vehicle are wheels.

14. The truck assembly of claim 11 wherein said rigid element is substantially c-shaped in the general plane of said ring-shaped member and includes a provision that permits its ends to be disposed a variable distance apart from one another, between which said kingpin is disposed.

15. The truck assembly of claim 11 wherein said rigid element includes a substantially trapezoidal-shaped bore in the general plane of said ring-shaped member through which said kingpin is disposed.

16. The truck assembly of claim 11 that includes at least one additional element that is directly or indirectly coupled to said rigid element or elements wherein the distance between said rigid element or elements and said kingpin in the direction generally parallel to the axis of said axle is determined by actuation of at least one said additional element.

17. The truck assembly of claim 11 wherein at least one washer, flat or otherwise formed, is placed between said rigid element or elements and said bushing assembly.

18. The truck assembly of claim 11 wherein said kingpin includes one or more flat areas along the shaft of said kingpin at or near the location or locations where said rigid element or elements may contact said kingpin.

19. The truck assembly of claim 1 wherein
said vehicle is a skateboard,
said device or devices secured to the opposite ends of said axle are wheels,
said ring-shaped member includes two bores that are longitudinally oriented in the general plane of said ring-shaped member substantially parallel to the axis of said axle and on generally opposite sides of said kingpin,
said ring-shaped member includes one set screw in each of said two bores.
thickness of a flange defined in said ring-shaped member is larger than the diameter of said set screw,
and said kingpin includes at least one flat area along the shaft of said kingpin at or near the location where at least one said set screws may contact said kingpin.

20. A truck assembly for a skateboard comprising:
a base configured to be secured to the underside of said skateboard, said base configured to have an underside that defines a pivot recess;
a modified kingpin including two flat areas along the shaft of said modified kingpin, said modified kingpin projecting downwardly from the underside of said base, from a location spaced from said pivot recess, wherein said modified kingpin is oriented at a specified angle towards said pivot recess, and wherein said modified kingpin and said pivot recess are configured to be aligned parallel to the primary direction of travel of said skateboard;
an axle assembly including
an axle,
a plurality of wheels secured to opposite ends of said axle,
a ring-shaped member projecting from a mid portion of said axle, said ring-shaped member defining an opening sized to be larger than the cross section of said modified kingpin, and said ring-shaped member including two bores that are longitudinally oriented in the general plane of said ring-shaped member substantially parallel to the axis of said axle and on generally opposite sides of said modified kingpin adjacent to said flat areas of said modified kingpin,
a pivot stem projecting from a mid portion of said axle, said pivot stem configured to be seated in said pivot recess,
wherein said axle assembly is secured to the underside of said base with said axle configured to be oriented substantially perpendicular to the primary direction of travel of said skateboard, with said pivot stem seated in said pivot recess, and with said ring-shaped member disposed around said modified kingpin, wherein a gap is defined between said ring-shaped member and said modified kingpin;
a bushing assembly disposed on said modified kingpin, said bushing assembly adjacent to said ring-shaped member, said bushing assembly permitting limited pivoting of said axle assembly about the axis of said modified kingpin; and
one set screw positioned in each of said two bores defined in said ring-shaped member adjacent to said flat area of said modified kingpin, wherein the distance between said set screw and said modified kingpin is determined by actuation of said set screw and wherein said set screw is formed of a sufficiently strong material and is sufficiently secure at its actuated location in said bore such that when said axle assembly pivots through an angle about the axis of said modified kingpin and causes at least one said set screw to contact said modified kingpin, said contacting set screw or screws resist any further pivoting of said axle assembly beyond that angle.
